(19) United States
(12) Patent Application Publication
(10) Pub. No.: US 2010/0115233 A1
(43) Pub. Date: May 6, 2010

(54) DYNAMICALLY-SELECTABLE VECTOR REGISTER PARTITIONING

(75) Inventors: Tony Brewer, Plano, TX (US); Steven J. Wallach, Dallas, TX (US)

Correspondence Address: FULBRIGHT & JAWORSKI L.L.P, 2200 ROSS AVENUE, SUITE 2800, DALLAS, TX, 75201-2784, US

(73) Assignee: Convey Computer, Richardson, TX (US)

(21) Appl. No.: 12/263,232

(22) Filed: Oct. 31, 2008

(51) Int. Cl. G06F 15/76; G06F 9/02

(52) U.S. Cl. 712/7; 712/E09.002

(57) ABSTRACT

The present invention is directed generally to dynamically-selectable vector register partitioning, and more specifically to a processor infrastructure (e.g., co-processor infrastructure in a multi-processor system) that supports dynamic setting of vector register partitioning to any of a plurality of different vector partitioning modes. Thus, rather than being restricted to a fixed vector register partitioning mode, embodiments of the present invention enable a processor to be dynamically set to any of a plurality of different vector partitioning modes. Thus, for instance, different vector register partitioning modes may be employed for different applications being executed by the processor, and/or different vector register partitioning modes may even be employed for use in processing different vector oriented operations within a given applications being executed by the processor, in accordance with certain embodiments of the present invention.

### CROSS-REFERENCE TO RELATED APPLICATIONS

The present application relates generally to the following co-pending and commonly-assigned U.S. Patent Applications: 1) U.S. patent application Ser. No. 11/841,406 (Attorney Docket No. 73225/P001US/10709871) filed Aug. 20, 2007 titled “MULTI-PROCESSOR SYSTEM HAVING AT LEAST ONE PROCESSOR THAT COMPRISES A DYNAMICALLY RECONFIGURABLE INSTRUCTION SET”, 2) U.S. patent application Ser. No. 11/854,432 (Attorney Docket No. 73225/P002US/10711918) filed Sep. 12 2007 titled “DISPATCH MECHANISM FOR DISPATCHING INSTRUCTIONS FROM A HOST PROCESSOR TO A CO-PROCESSOR”, 3) U.S. patent application Ser. No. 11/847,169 (Attorney Docket No. 73225/P003US/10711914) filed Aug. 29, 2007 titled “COMPILER FOR GENERATING AN EXECUTABLE COMPRISING INSTRUCTIONS FOR A PLURALITY OF DIFFERENT INSTRUCTION SETS”, 4) U.S. patent application Ser. No. 11/969,792 (Attorney Docket No. 73225/P004US/10717402) filed Jan. 4, 2008 titled “MICROPROCESSOR ARCHITECTURE HAVING ALTERNATIVE MEMORY ACCESS PATHS”, 5) U.S. patent application Ser. No. 12/186,344 (Attorney Docket No. 73225/P005US/10804745) filed Aug. 5, 2008 titled “MEMORY INTERLEAVE FOR HETEROGENEOUS COMPUTING”, 6) U.S. patent application Ser. No. 12/186,372 (Attorney Docket No. 73225/P006US/10804746) filed Aug. 5, 2008 titled “MULTIPLE DATA CHANNEL MEMORY MODULE ARCHITECTURE”, and 7) concurrently-filed U.S. patent application Ser. No. ______ (Attorney Docket No. 73225/P007US/10813516) titled “CO-PROCESSOR INFRASTRUCTURE SUPPORTING DYNAMICALLY-MODIFIABLE PERSONALITIES”, the disclosures of which are hereby incorporated herein by reference.

### TECHNICAL FIELD

The following description relates generally to dynamically-selectable vector register partitioning, and more specifically to a co-processor infrastructure that supports dynamic setting of vector register partitioning to any of a plurality of different vector partitioning modes.

### BACKGROUND AND RELATED ART

1. Background

The popularity of computing systems continues to grow and the demand for improved processing architectures thus likewise continues to grow. Ever-increasing desires for improved computing performance and efficiency has led to various improved processor architectures. For example, multi-core processors are becoming more prevalent in the computing industry and are being used in various computing devices, such as servers, personal computers (PCs), laptop computers, personal digital assistants (PDAs), wireless telephones, and so on.

In the past, processors such as CPUs (central processing units) featured a single execution unit to process instructions of a program. More recently, computer systems are being developed with multiple processors in an attempt to improve the computing performance of the system. In some instances, multiple independent processors may be implemented in a system. In other instances, a multi-core architecture may be employed, in which multiple processor cores are amassed on a single integrated silicon die. Each of the multiple processors (e.g., processor cores) can simultaneously execute program instructions. This parallel operation of the multiple processors can improve performance of a variety of applications.

A multi-core CPU combines two or more independent cores into a single package comprised of a single piece silicon integrated circuit (IC), called a die. In some instances, a multi-core CPU may comprise two or more dies packaged together. A dual-core device contains two independent microprocessors and a quad-core device contains four microprocessors. Cores in a multi-core device may share a single coherent cache at the highest on-device cache level (e.g., L2 for the Intel® Core 2) or may have separate caches (e.g. current AMD® dual-core processors). The processors also share the same interconnect to the rest of the system. Each “core” may independently implement optimizations such as superscalar execution, pipelining, and multithreading. A system with N cores is typically most effective when it is presented with N or more threads concurrently.

One processor architecture that has been developed utilizes multiple processors (e.g., multiple cores), which are homogeneous. The processors are homogeneous in that they are all implemented with the same fixed instruction sets (e.g., Intel's x86 instruction set, AMD's Opteron instruction set, etc.). Further, the homogeneous processors access memory in a common way, such as all of the processors being cache-line oriented such that they access a cache block (or “cache line”) of memory at a time.

In general, a processor's instruction set refers to a list of all instructions, and all their variations, that the processor can execute. Such instructions may include, as examples, arithmetic instructions, such as ADD and SUBTRACT; logic instructions, such as AND, OR, and NOT; data instructions, such as MOVE, INPUT, OUTPUT, LOAD, and STORE; and control flow instructions, such as GOTO, if X then GOTO, CALL, and RETURN. Examples of well-known instruction sets include x86 (also known as IA-32), x86-64 (also known as AMD64 and Intel® 64), AMD's Opteron, VAX (Digital Equipment Corporation), IA-64 (Itanium), and PA-RISC (LIP Precision Architecture).

Generally, the instruction set architecture is distinguished from the microarchitecture, which is the set of processor design techniques used to implement the instruction set. Computers with different microarchitectures can share a common instruction set. For example, the Intel® Pentium and the AMD® Athlon implement nearly identical versions of the x86 instruction set, but have radically different internal microarchitecture designs. In all these cases the instruction set (e.g., x86) is fixed by the manufacturer and directly hardware implemented, in a semiconductor technology, by the microarchitecture. Consequently, the instruction set is traditionally fixed for the lifetime of this implementation.

FIG. 1 shows a block-diagram representation of an exemplary prior art system 100 in which multiple homogeneous processors (or cores) are implemented. System 100 comprises two subsystems: 1) a main memory (physical memory) subsystem 101 and 2) a processing subsystem 102 (e.g., a multi-core die). System 100 includes a first microprocessor core 104A and a second microprocessor core 104B. In this example, microprocessor cores 104A and 104B are homogeneous in that they are each implemented to have the same, fixed instruction set, such as x86. In addition, each of the homogeneous microprocessor cores 104A and 104B access main memory 101 in a common way, such as via cache block accesses, as discussed hereafter. Further, in this example, cores 104A and 104B are implemented on a common die 102. Main memory 101 is communicatively connected to processing subsystem 102. Main memory 101 comprises a common physical address space that microprocessor cores 104A and 104B can each reference.

As shown further in FIG. 1, a cache 103 is also implemented on die 102. Cores 104A and 104B are each communicatively coupled to cache 103. As is well known, a cache generally is memory for storing a collection of data duplicating original values stored elsewhere (e.g., to main memory 101) or computed earlier, where the original data is expensive to fetch (due to longer access time) or to compute, compared to the cost of reading the cache. In other words, a cache 103 generally provides a temporary storage area where frequently accessed data can be stored for rapid access. Once the data is stored in cache 103, future use can be made by accessing the cached copy rather than re-fetching the original data from main memory 101, so that the average access time is shorter. In many systems, cache access times are approximately 50 times faster than similar accesses to main memory 101. Cache 103, therefore, helps expedite data access that the micro-cores 104A and 104B would otherwise have to fetch from main memory 101.

In many system architectures, each core 104A and 104B will have its own cache also, commonly called the “L1” cache, and cache 103 is commonly referred to as the “L2” cache. Unless expressly stated herein, cache 103 generally refers to any level of cache that may be implemented, and thus may encompass L1, L2, etc. Accordingly, while shown for ease of illustration as a single block that is accessed by both of cores 104A and 104B, cache 103 may include L1 cache that is implemented for each core.

In many system architectures, virtual addresses are utilized. In general, a virtual address is an address identifying a virtual (non-physical) entity. As is well-known in the art, virtual addresses may be utilized for accessing memory. Virtual memory is a mechanism that permits data that is located on a persistent storage medium (e.g., disk) to be referenced as if the data was located in physical memory. Translation tables, maintained by the operating system, are used to determine the location of the reference data (e.g., disk or main memory). Program instructions being executed by a processor may refer to a virtual memory address, which is translated into a physical address. To minimize the performance penalty of address translation, most modern CPUs include an on-chip Memory Management Unit (MMU), and maintain a table of recently used virtual-to-physical translations, called a Translation Look-aside Buffer (TLB). Addresses with entries in the TLB require no additional memory references (and therefore time) to translate. However, the TLB can only maintain a fixed number of mappings between virtual and physical addresses; when the needed translation is not resident in the TLB, action will have to be taken to load it in.

In some architectures, special-purpose processors that are often referred to as “accelerators” are also implemented to perform certain types of operations. For example, a processor executing a program may offload certain types of operations to an accelerator that is configured to perform those types of operations efficiently. Such hardware acceleration employs hardware to perform some function faster than is possible in software running on the normal (general-purpose) CPU. Hardware accelerators are generally designed for computationally intensive software code. Depending upon granularity, hardware acceleration can vary from a small function unit to a large functional block like motion estimation in MPEG2. Examples of such hardware acceleration include blitting acceleration functionality in graphics processing units (GPUs) and instructions for complex operations in CPUs. Such accelerator processors generally have a fixed instruction set that differs from the instruction set of the general-purpose processor, and the accelerator processor's local memory does not maintain cache coherency with the general-purpose processor.

A graphics processing unit (GPU) is a well-known example of an accelerator. A GPU is a dedicated graphics rendering device commonly implemented for a personal computer, workstation, or game console. Modern GPUs are very efficient at manipulating and displaying computer graphics, and their highly parallel structure makes them more effective than typical CPUs for a range of complex algorithms. A GPU implements a number of graphics primitive operations in a way that makes running them much faster than drawing directly to the screen with the host CPU. The most common operations for early two-dimensional (2D) computer graphics include the BitBLT operation (combines several bitmap patterns using a RasterOp), usually in special hardware called a “blitter”, and operations for drawing rectangles, triangles, circles, and arcs. Modern GPUs also have support for three-dimensional (3D) computer graphics, and typically include digital video-related functions.

Thus, for instance, graphics operations of a program being executed by host processors 104A and 104B may be passed to a GPU. While the homogeneous host processors 104A and 104B maintain cache coherency with each other, as discussed above with FIG. 1, they do not maintain cache coherency with accelerator hardware of the GPU. In addition, the GPU accelerator does not share the same physical or virtual address space of processors 104A and 104B.

In multi-processor systems, such as exemplary system 100 of FIG. 1 one or more of the processors may be implemented as a vector processor. In general, vector processors are processors which provide high level operations on vectors—that is, linear arrays of data. As one example, a typical vector operation might add two 64-entry, floating point vectors to obtain a single 64-entry vector. In effect, one vector instruction is generally equivalent to a loop with each iteration computing one of the 64 elements of the result, updating all the indices and branching back to the beginning. Vector operations are particularly useful for certain types of processing, such as image processing or processing of certain scientific or engineering applications where large amounts of data is desired to be processed in generally a repetitive manner. In a vector processor, the computation of each result is generally independent of the computation of previous results, thereby allowing a deep pipeline without generating data dependencies or conflicts. In essence, the absence of data dependencies is determined by the particular application to which the vector processor is applied, or by the compiler when a particular vector operation is specified. Traditional vector processors typically include a pipeline scalar unit together with a vector unit. In vector-register processors, the vector operations, except loads and stores, use the vector registers. A processor may include vector registers for storing vector operands and/or vector results. Traditionally, a fixed vector register partitioning scheme is employed within such a vector processor.

In most systems, memory 101 may hold both programs and data. Each has unique characteristics pertinent to memory performance. For example, when a program is being executed, memory traffic is typically characterized as a series of sequential reads. On the other hand, when a data structure is being accessed, memory traffic is usually characterized by a stride, i.e., the difference in address from a previous access. A stride may be random or fixed. For example, repeatedly accessing a data element in an array may result in a fixed stride of two. As is well-known in the art, a lot of algorithms have a power of 2 stride. Accordingly, without some memory interleave management scheme being employed, hot spots may be encountered within the memory in which a common portion of memory (e.g., a given bank of memory) is accessed much more often than other portions of memory.

As is well-known in the art, memory is often arranged into independently controllable arrays, often referred to as “memory banks.” Under the control of a memory controller, a bank can generally operate on one transaction at a time. The memory may be implemented by dynamic storage technology (such as “DRAMS”), or of static RAM technology. In a typical DRAM chip, some number (e.g., 4, 8, and possibly 16) of banks of memory may be present. A memory interleaving scheme may be desired to minimize one of the banks of memory from being a “hot spot” of the memory.

As discussed above, many compute devices, such as the Intel x86 or AMD x86 microprocessors, are cache-block oriented. Today, a cache block of 64 bytes in size is typical, but compute devices may be implemented with other cache block sizes. A cache block is typically contained all on a single hardware memory storage element, such as a single dual in-line memory module (DIMM). As discussed above, when the cache-block oriented compute device accesses that DIMM, it presents one address and is returned the entire cache-block (e.g., 64 bytes).

Some compute devices, such as certain accelerator compute devices, may not be cache-block oriented. That is, those non-cache-block oriented compute devices may access portions of memory (e.g., words) on a much smaller, finer granularity than is accessed by the cache-block oriented compute devices. For instance, while a typical cache-block oriented compute device may access a cache block of 64 bytes for a single memory access request, a non-cache-block oriented compute device may access a Word that is 8 bytes in size in a single memory access request. That is, the non-cache-block oriented compute device in this example may access a particular memory DIMM and only obtain 8 bytes from a particular address present in that DIMM.

As discussed above, traditional multi-processor systems have employed homogeneous compute devices (e.g., processor cores 104A and 104B of FIG. 1) that each access memory 101 in a common manner, such as via cache-block oriented accesses. While some systems may further include certain heterogeneous compute elements, such as accelerators (e.g., a GPU), the heterogeneous compute element does not share the same physical or virtual address space of the homogeneous compute elements.

2. Related Art

More recently, some systems have been developed that include heterogeneous compute elements. For instance, the above-identified related U.S. patent applications (the disclosures of which are incorporated herein by reference) disclose various implementations of exemplary heterogeneous computing architectures. In certain implementations, the architecture comprises a multi-processor system having at least one host processor and one or more heterogeneous co-processors. Further, in certain implementations, at least one of the heterogeneous co-processors may be dynamically reconfigurable to possess any of various different instruction sets. The host processor(s) may comprise a fixed instruction set, such as the well-known x86 instruction set, while the co-processor(s) may comprise dynamically reconfigurable logic that enables the co-processor's instruction set to be dynamically reconfigured. In this manner, the host processor(s) and the dynamically reconfigurable co-processor(s) are heterogeneous processors because the dynamically reconfigurable co-processor(s) may be configured to have a different instruction set than that of the host processor(s).

According to certain embodiments, the co-processor(s) may be dynamically reconfigured with an instruction set for use in optimizing performance of a given executable. For instance, in certain embodiments, one of a plurality of predefined instruction set images may be loaded onto the co-processor(s) for use by the co-processor(s) in processing a portion of a given executable's instruction stream. Thus, certain instructions being processed for a given application may be off-loaded (or “dispatched”) from the host processor(s) to the heterogeneous co-processor(s) which may be configured to process the off-loaded instructions in a more efficient manner.

Thus, in certain implementations, the heterogeneous co-processor(s) comprise a different instruction set than the native instruction set of the host processor(s). Further, in certain embodiments, the instruction set of the heterogeneous co-processor(s) may be dynamically reconfigurable. As an example, in one implementation at least three (3) mutually-exclusive instruction sets may be pre-defined, any of which may be dynamically loaded to a dynamically-reconfigurable heterogeneous co-processor. As an illustrative example, a first pre-defined instruction set might be a vector instruction set designed particularly for processing 64-bit floating point operations as are commonly encountered in computer-aided simulations; a second pre-defined instruction set might be designed particularly for processing 32-bit floating point operations as are commonly encountered in signal and image processing applications; and a third pre-defined instruction set might be designed particularly for processing cryptography-related operations. While three illustrative pre-defined instruction sets are mention above, it should be recognized that embodiments of the present invention are not limited to the exemplary instruction sets mentioned above. Rather, any number of instruction sets of any type may be pre-defined in a similar manner and may be employed on a given system in addition to or instead of one or more of the above-mentioned pre-defined instruction sets.

In certain implementations, the heterogeneous compute elements (e.g., host processor(s) and co-processor(s)) share a common physical and/or virtual address space of memory. As an example, a system may comprise one or more host processor(s) that are cache-block oriented, and the system may further comprise one or more compute elements co-processor(s) that are non-cache-block oriented. For instance, the cache-block oriented compute element(s) may access main memory in cache blocks of, say, 64 bytes per request, whereas the non-cache-block oriented compute element(s) may access main memory via smaller-sized requests (which may be referred to as “sub-cache-block” requests), such as 8 bytes per request.

One exemplary heterogeneous computing system that may include one or more cache-block oriented compute elements and one or more non-cache-block oriented compute elements is that disclosed in co-pending U.S. patent application Ser. No. 11/841,406 (Attorney Docket No. 73225/P001US/10709871) filed Aug. 20, 2007 titled “MULTI-PROCESSOR SYSTEM HAVING AT LEAST ONE PROCESSOR THAT COMPRISES A DYNAMICALLY RECONFIGURABLE INSTRUCTION SET”, the disclosure of which is incorporated herein by reference. For instance, in such a heterogeneous computing system, one or more host processors may be cache-block oriented, while one or more of the dynamically-reconfigurable co-processor(s) may be non-cache-block oriented, and the heterogeneous host processor(s) and co-processor(s) share access to the common main memory (and share a common physical and virtual address space of the memory).

Another exemplary heterogeneous computing system is that disclosed in co-pending U.S. patent application Ser. No. 11/969,792 (Attorney Docket No. 73225/P004US/10717402) filed Jan. 4, 2008 titled “MICROPROCESSOR ARCHITECTURE HAVING ALTERNATIVE MEMORY ACCESS PATHS” (hereinafter “the '792 application”), the disclosure of which is incorporated herein by reference. In particular, the '792 application discloses an exemplary heterogeneous compute system in which one or more compute elements (e.g., host processors) are cache-block oriented and one or more heterogeneous compute elements (e.g., co-processors) are sub-cache-block oriented to access data at a finer granularity than the cache block.

While the above-referenced related applications describe exemplary heterogeneous computing systems in which embodiments of the present invention may be implemented, the concepts presented herein are not limited in application to those exemplary heterogeneous computing systems but may likewise be employed in other systems/architectures.

### SUMMARY

As mentioned above, traditional vector processors may employ a fixed vector register partitioning scheme. That is, vector registers of a processor are traditionally partitioned in accordance with a predefined partitioning scheme, and the vector registers remain partitioned in that manner, irrespective of the type of application being executed or the type of vector processing operations being performed by the vector processor.

The present invention is directed generally to dynamically-selectable vector register partitioning, and more specifically to a processor infrastructure (e.g., co-processor infrastructure in a multi-processor system) that supports dynamic setting of vector register partitioning to any of a plurality of different vector partitioning modes. Thus, rather than being restricted to a fixed vector register partitioning mode, embodiments of the present invention enable a processor to be dynamically set to any of a plurality of different vector partitioning modes. Thus, for instance, different vector register partitioning modes may be employed for different applications being executed by the processor, and/or different vector register partitioning modes may even be employed for use in processing different vector oriented operations within a given applications being executed by the processor, in accordance with certain embodiments of the present invention.

According to one embodiment, a method for processing data comprises analyzing structure of data to be processed, and selecting one of a plurality of vector register partitioning modes based on said analyzing. In certain embodiments, the method further comprises dynamically setting a processor (e.g., co-processor in a multi-processor system) to use the selected one of the plurality of vector register partitioning modes for vector registers of the processor. The selecting may comprise selecting the vector register partitioning mode to optimize performance of vector processing operations by the processor.

In certain embodiments, the processor comprises a plurality of application engines, where each of the application engines comprises a plurality of function pipes for performing vector processing operations, and where each of the function pipes comprises a set of vector registers. Each vector register may contain multiple elements. In certain embodiments, each data element may be 8 bytes in size; but, in other embodiments, the size of each element of a vector register may differ from 8 bytes (i.e., may be larger or smaller). In certain embodiments, the plurality of vector register modes comprise at least a) a classic vector mode in which all vector register elements of the processor form a single partition, b) a physical partition mode in which vector register elements of each of the application engines form a separate partition, and c) a short vector mode in which the vector register elements of each of the function pipes form a separate partition.

According to one embodiment, a co-processor in a multi-processor system comprises at least one application engine having vector registers that comprise vector register elements for storing data for vector oriented operations by the application engine(s). The application engine(s) can be dynamically set to any of a plurality of different vector register partitioning modes, wherein the vector register elements are partitioned according to the vector register partitioning mode to which the application engine(s) is/are dynamically set.

According to one embodiment, a method comprises initiating an executable file for processing instructions of the executable file by a multi-processor system, wherein the multi-processor system comprises a host processor and a co-processor. The method further comprises setting the co-processor to a selected one of a plurality of different vector register partitioning modes, wherein the selected vector register partitioning mode defines how vector register elements of the co-processor are partitioned for use in performing vector oriented operations for processing a portion of the instructions of the executable file. The method further comprises processing, by the multi-processor system, the instructions of the executable file, wherein a portion of the instructions are processed by the host processor and a portion of the instructions are processed by the co-processor.

In certain embodiments, a processor employs a common vector processing approach, wherein a vector is stored in a vector register. Vector registers may contain operand vectors that are used in performing vector oriented operations, and/or vector registers may contain result vectors that are obtained as a result of performing vector oriented operations, as examples. A vector may be many data elements in size. Data elements of a vector register may be organized as single or multi-dimensional array. For example, each vector register may be a one-dimensional, two-dimensional, three-dimensional, or even other “N”-dimensional array of data in accordance with embodiments of the present invention. So, for example, there may be 64 vector registers in a register file, and each of those 64 registers may have a large number of data elements associated with it. Such use of vector registers is a common approach to handling vector oriented data.

As one example, a processor may provide a total/maximum vector register size of, say, 1024 elements per vector register. However, for certain applications and/or for certain vector oriented operations to be performed during execution of an application, the total/maximum vector register size is larger than needed, in which case all of the data elements are not used to solve the problem. Whatever is not being used results in an inefficiency and the peek performance goes down proportionally.

So, certain embodiments of the present invention, provide a dynamically-selectable vector register partitioning mechanism, wherein the total/maximum size of the vector register, e.g., 1024 data element size, may be selectively partitioned into many smaller elements that are still acting in the same SIMD (Single Instruction Multiple Data) manner.

As an example, in one embodiment, a co-processor in a multi-processor system comprises four application engines that each have eight function pipes. Each function pipe contains a functional logic for performing vector oriented operations, and contains a 32 element size vector register. Thus, because each application engine contains eight function pipes that each have 32 vector register elements, each application engine contains a total of 256 (8×32) vector register elements per vector register. And, because there are four of such application engines, the co-processor has a total vector of 1024 (4×256) vector register elements per vector register. The application engines can be dynamically set to any of a plurality of different vector register partitioning modes. In certain embodiments, the plurality of vector register modes to which the application engines may be dynamically set comprise at least a) a classic vector mode in which all vector register elements of the processor form a single partition (i.e., each vector register is 1024 elements in size), b) a physical partition mode in which vector register elements of each of the application engines form a separate partition (i.e., each vector register is 256 elements in size), and c) a short vector mode in which the vector register elements of each of the function pipes form a separate partition (i.e., each vector register is 32 elements in size). While exemplary numbers of application engines and functional units are mentioned above, as well as exemplary sizes of vector registers, the scope of the present invention is not limited to any specific number of application engines, functional units, or to the above-mentioned exemplary vector register sizes; but rather the co-processor may be similarly implemented having any number of application engines (one or more) that each have any number of functional units (one or more) that employ any size vector register (e.g., any number of elements), and the dynamic setting of vector register partitioning may be likewise employed in accordance with embodiments of the present invention.

In addition, exemplary systems such as those disclosed in the above-referenced U.S. patent applications have been developed that include one or more dynamically-reconfigurable co-processors such that any of various different personalities can be loaded onto the configurable part of the co-processor(s). In this context, a “personality” generally refers to a set of instructions recognized by the co-processor. According to certain embodiments of the present invention, a co-processor is provided that includes one or more application engines that are dynamically configurable to any of a plurality of different personalities. For instance, the application engine(s) may comprise one or more reconfigurable function units (e.g., the reconfigurable function units may be implemented with FPGAs, etc.) that can be dynamically configured to implement a desired extended instruction set.

As discussed further in concurrently-filed and commonly-assigned U.S. patent application Ser. No. ______ (Attorney Docket No. 73225/P007US/10813516) titled “CO-PROCESSOR INFRASTRUCTURE SUPPORTING DYNAMICALLY-MODIFIABLE PERSONALITIES”, the disclosure of which is incorporated herein by reference, the co-processor may also comprises an infrastructure that is common to all the different personalities (e.g., different vector processing personalities) to which the application engines may be configured. In certain embodiments, the infrastructure comprises an instruction decode infrastructure that is common across all of the personalities. In certain embodiments, the infrastructure comprises a memory management infrastructure that is common across all of the personalities. Such memory management infrastructure may comprise a virtual memory and/or physical memory infrastructure that is common across all of the personalities. In certain embodiments, the infrastructure comprises a system interface infrastructure (e.g., for interfacing with a host processor) that is common across all of the personalities. In certain embodiments, the infrastructure comprises a scalar processing unit having a base set of instructions that are common across all of the personalities. All or any combination of (e.g., any one or more of) an instruction decode infrastructure, memory management infrastructure, system interface infrastructure, and scalar processing unit may be implemented to be common across all of the personalities in a given co-processor in accordance with embodiments of the present invention.

Accordingly, certain embodiments of the present invention provide a co-processor that comprises one or more application engines that can be dynamically configured to a desired personality. The co-processor further comprises a common infrastructure that is common across all of the personalities, such as an instruction decode infrastructure, memory management infrastructure, system interface infrastructure, and/or scalar processing unit (that has a base set of instructions). Thus, the personality of the co-processor can be dynamically modified (by reconfiguring one or more application engines of the co-processor), while the common infrastructure of the co-processor remains consistent across the various personalities.

According to certain embodiments, the co-processor supports at least two dynamically-configurable general-purpose vector processing personalities. In general, a vector processing personality refers to a personality (i.e., a set of instructions recognized by the co-processor) that includes specific instructions for vector operations. The first general-purpose vector processing personality to which the co-processor may be configured is referred to as single precision vector (SPV), and the second general-purpose vector processing personality to which the co-processor may be configured is referred to as double precision vector (DPV).

For different markets or different types of applications, specific extensions of the canonical instructions may be developed to be efficient at solving a particular problem for the corresponding market. Thus, a corresponding “personality” may be developed for a given type of application. As an example, many seismic data processing applications (e.g., “oil and gas” applications) require single-precision type vector processing operations, while many financial applications require double-precision type vector processing operations (e.g., financial applications commonly need special instructions to be able to do intrinsics, log, exponential, cumulative distribution function, etc.). Thus, a SPV personality may be provided for use by the co-processor in processing applications that desire single-precision type vector processing operations (e.g., seismic data processing applications), and a DPV personality may be provided for use by the co-processor in processing applications that desire double-precision type vector processing operations (e.g., financial applications).

Depending on the type of application being executed at a given time, the co-processor may be dynamically configured to possess the desired vector processing personality. As one example, upon starting execution of an application that desires a SPV personality, the co-processor may be checked to determine whether it possesses the desired SPV personality, and if it does not, it may be dynamically configured with the SPV personality for use in executing at least a portion of the operations desired in executing the application. Thereafter, upon starting execution of an application that desires a DPV personality, the co-processor may be dynamically reconfigured to possess the DPV personality for use in executing at least a portion of the operations desired in executing that application. In certain embodiments, the personality of the co-processor may even be dynamically modified during execution of a given application. For instance, in certain embodiments, the co-processor's personality may be configured to a first personality (e.g., SPV personality) for execution of a portion of the operations desired by an executing application, and then the co-processor's personality may be dynamically reconfigured to another personality (e.g., DPV personality) for execution of a different portion of the operations desired by an executing application. The co-processor can be dynamically configured to possess a desired personality for optimally supporting operations (e.g., accurately, efficiently, etc.) of an executing application.

In one embodiment, the various vector processing personalities to which the co-processor can be configured provide extensions to the canonical ISA (instruction set architecture) that support vector oriented operations. The SPV and DPV personalities are appropriate for single and double precision workloads, respectively, with data organized as single or multi-dimensional arrays. Thus, according to one embodiment of the present invention, a co-processor is provided that has an infrastructure that can be leveraged across various different vector processing personalities, which may be achieved by dynamically modifying function units of the co-processor, as discussed further herein.

While SPV and DPV are two exemplary vector processing personalities to which the co-processor may be dynamically configured to possess in certain embodiments, the scope of the present invention is not limited to those exemplary vector processing personalities; but rather the co-processor may be similarly dynamically reconfigured to any number of other vector processing personalities (and/or non-vector processing personalities that do not comprise instructions for vector oriented operations) in addition to or instead of SPV and DPV in accordance with embodiments of the present invention. And, in certain embodiments of the present invention, the co-processor personality may not be dynamically reconfigurable. Rather, in certain embodiments the co-processor personality may be fixed, and the vector register partitioning mode may still be dynamically set for the co-processor in the manner described further herein.

Further, in addition to dynamically configuring the vector processing personality of the co-processor's application engines, certain embodiments of the present invention also enable dynamic setting of the vector register partitioning mode that is employed by the co-processor. For instance., different vector register partitioning modes may be desired for different vector processing personalities. In addition, in some instances, different vector register partitioning modes may be dynamically selected for use within a given vector processing personality.

Thus, according to certain embodiments, a system for processing data comprises at least one application engine having at least one configurable function unit that is configurable to any of a plurality of different vector processing personalities. The system further comprises an infrastructure that is common to all of the plurality of different vector processing personalities. The system further comprises vector registers for storing data for vector oriented operations by the application engine(s). The application engine(s) can be dynamically set to any of a plurality of different vector register partitioning modes, wherein the vector register partitioning mode to which the application engine(s) is/are dynamically set defines how the vector register elements are partitioned.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows an exemplary prior art multi-processor system employing a plurality of homogeneous processors;

FIG. 2 shows an exemplary multi-processor system according to one embodiment of the present invention, wherein a co-processor comprises one or more application engines that are dynamically configurable to any of a plurality of different personalities (e.g., vector processing personalities);

FIG. 3 shows an exemplary implementation of application engines of the co-processor of FIG. 2 being configured to possess a single precision vector (SPV) personality;

FIG. 4 shows one example of a plurality of different vector register partitioning modes that may be supported within the exemplary co-processor 22 of FIGS. 2-3;

FIG. 5 shows an exemplary application engine control register that may be implemented in certain embodiments for dynamically setting the co-processor to any of a plurality of different vector register partitioning modes;

FIGS. 6A and 6B show how data elements are mapped among function pipes in one exemplary vector register partitioning mode (“classic vector mode”) for different vector lengths, according to one embodiment;

FIG. 7 shows how data elements are mapped among function pipes in another exemplary vector register partitioning mode (“physical partition mode”) for a certain vector length, according to one embodiment;

FIG. 8 shows how data elements are mapped among function pipes in another exemplary vector register partitioning mode (“short vector mode”) for a certain vector length, according to one embodiment;

FIG. 9 graphically illustrates one example of using vector register partitioning in one embodiment;

FIG. 10 graphically illustrates another example of using vector register partitioning in one embodiment; and

FIG. 11 shows an example of employing vector partition scalars according to one embodiment of the present invention.

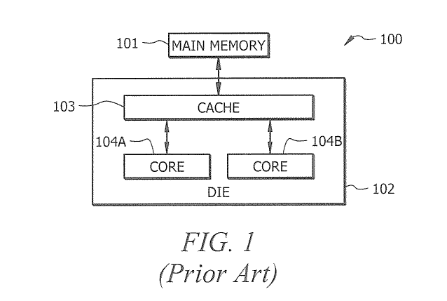

### DETAILED DESCRIPTION

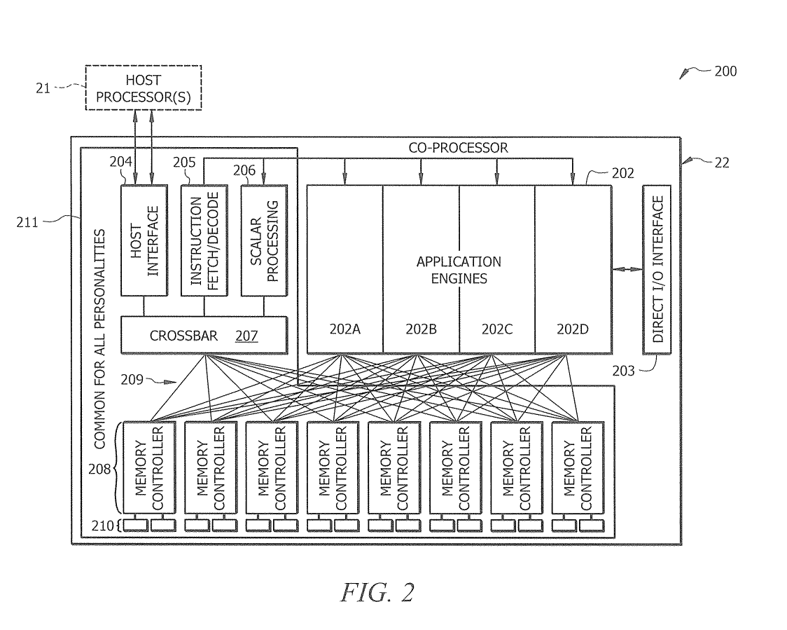

FIG. 2 shows an exemplary multi-processor system 200 according to one embodiment of the present invention. Exemplary system 200 comprises a plurality of processors, such as one or more host processors 21 and one or more co-processors 22. As disclosed in the related U.S. patent applications referenced herein above, the host processor(s) 21 may comprise a fixed instruction set, such as the well-known x86 instruction set, while the co-processor(s) 22 may comprise dynamically reconfigurable logic that enables the co-processor's instruction set to be dynamically reconfigured. Of course, embodiments of the present invention are not limited to any specific instruction set that may be implemented on host processor(s) 21. FIG. 2 further shows, in block-diagram form, an exemplary architecture of co-processor 22 that may be implemented in accordance with one embodiment of the present invention.

It should be recognized that embodiments of the present invention may be adapted to any appropriate scale or granularity within a given system. For instance, a host processor(s) 21 and co-processor(s) 22 may be implemented as separate processors (e.g., which may be implemented on separate integrated circuits). In other architectures, such host processor(s) 21 and co-processor(s) 22 may be implemented within a single integrated circuit (i.e., the same physical die).

While one co-processor 22 is shown for ease of illustration in FIG. 2, it should be recognized that any number of such co-processors may be implemented in accordance with embodiments of the present invention, each of which may be dynamically reconfigurable to possess any of a plurality of different personalities (wherein the different co-processors may be configured with the same or with different personalities). For instance, two or more co-processors 22 may be configured with different personalities (instruction sets) and may each be used for processing instructions from a common executable (application). For example, an executable may designate a first instruction set to be configured onto a first of the co-processors and a second instruction set to be configured onto a second of the co-processors, wherein a portion of the executable's instruction stream may be processed by the host processor 21 while other portions of the executable's instruction stream may be processed by the first and second co-processors.

In the exemplary architecture shown in FIG. 2, co-processor 22 comprises one or more application engines 202 that may have dynamically-reconfigurable personalities, and co-processor 22 further comprises an infrastructure 211 that is common to all of the different personalities to which application engines 202 may be configured. Of course, embodiments of the present invention are not limited to processors having application engines with dynamically-reconfigurable personalities. That is, while the personalities of application engines 202 are dynamically reconfigurable in the example of FIG. 2, in other embodiments, the personalities (instruction sets) may not be dynamically reconfigurable, but in either case the vector register partitioning mode employed by the application engines is dynamically selectable in accordance with embodiments of the present invention. Exemplary embodiments of application engines 202 and infrastructure 211 are described further herein.

In the illustrative example of FIG. 2, co-processor 22 includes four application engines 202A-202D. While four application engines are shown in this illustrative example, the scope of the present invention is not limited to any specific number of application engines; but rather any number (one or more) of application engines may be implemented in a given co-processor in accordance with embodiments of the present invention. Each application engine 202A-202D is dynamically reconfigurable with any of various different personalities, such as by loading the application engine with an extended instruction set. Each application engine 202A-202D is operable to process instructions of an application (e.g., instructions of an application that have been dispatched from the host processor 21 to the co-processor 22) in accordance with the specific personality (e.g., extended instruction set) with which the application engine has been configured. The application engines 202 may comprise dynamically reconfigurable logic, such as field-programmable gate arrays (FPGAs), that enable a different personality to be dynamically loaded onto the application engine. Exemplary techniques that may be employed in certain embodiments for dynamically reconfiguring a co-processor (e.g., application engine) with a desired personality (instruction set) are described further in the above-referenced U.S. patent applications, the disclosures of which are incorporated herein by reference.

As discussed above, in this context a “personality” generally refers to a set of instructions recognized by the application engine 202. In certain implementations, the personality of a dynamically-reconfigurable application engine 202 can be modified by loading different extensions (or “extended instructions”) thereto in order to supplement or extend a base set of instructions. For instance, in one implementation, a canonical (or “base”) set of instructions is implemented in the co-processor (e.g., in scalar processing unit 206), and those canonical instructions provide a base set of instructions that remain present on the co-processor 22 no matter what further personality or extended instructions are loaded onto the application engines 202. As noted above, for different markets or types of applications, specific extensions of the canonical instructions may be desired in order to improve efficiency and/or other characteristics of processing the application being executed. Thus, for instance, different extended instruction sets may be developed to be efficient at solving particular problems for various types of applications. As an example, many seismic data processing applications require single-precision type vector processing operations, while many financial applications require double-precision type vector processing operations. Scalar processing unit 206 may provide a base set of instructions (a base ISA) that are available across all personalities, while any of various different personalities (or extended instruction sets) may be dynamically loaded onto the application engines 202 in order to configure the co-processor 22 optimally for a given type of application being executed.

In the example of FIG. 2, infrastructure 211 of co-processor 22 includes host interface 204, instruction fetch decode unit 205, scalar processing unit 206, crossbar 207, communication paths (bus) 209, memory controllers 208, and memory 210. Host interface 204 is used to communicate with the host processor(s) 21. In certain embodiments, host interface 204 may deal with dispatch requests for receiving instructions dispatched from the host processor(s) for processing by co-processor 22. Further, in certain embodiments, host interface 204 may receive memory interface requests between the host processor(s) 21 and the co-processor memory 210 and/or between the co-processor 22 and the host processor memory. Host interface 204 is connected to crossbar 207, which acts to communicatively interconnect various functional blocks, as shown.

When co-processor 22 is executing instructions, instruction fetch/decode unit 205 fetches those instructions from memory and decodes them. Instruction fetch/decode unit 205 may then send the decoded instructions to the application engines 202 or to the scalar processing unit 206.

Scalar processing unit 206, in this exemplary embodiment, is where the canonical, base set of instructions are executed. While one scalar processing unit is shown in this illustrative example, the scope of the present invention is not limited to one scalar processing unit; but rather any number (one or more) of scalar processing units may be implemented in a given co-processor in accordance with embodiments of the present invention. Scalar processing unit 206 is also connected to the crossbar 207 so that the canonical loads and stores can go either through the host interface 204 to the host processor(s) memory or through the crossbar 207 to the co-processor memory 210.

In this exemplary embodiment, co-processor 22 further includes one or more memory controllers 208. While eight memory controllers 208 are shown in this illustrative example, the scope of the present invention is not limited to any specific number of memory controllers; but rather any number (one or more) of memory controllers may be implemented in a given co-processor in accordance with embodiments of the present invention. In this example, memory controllers 208 perform the function of receiving a memory request from either the application engines 202 or the crossbar 207, and the memory controller then performs a translation from virtual address to physical address and presents the request to the memory 210 themselves.

Memory 210, in this example, comprises a suitable data storage mechanism, examples of which include, but are not limited to, either a standard dual in-line memory module (DIMM) or a multi-data channel DIMM such as that described further in co-pending and commonly-assigned U.S. patent application Ser. No. 12/186,372 (Attorney Docket No. 73225/P006US/10804746) filed Aug. 5, 2008 titled “MULTIPLE DATA CHANNEL MEMORY MODULE ARCHITECTURE,” the disclosure of which is hereby incorporated herein by reference. While a pair of memory modules are shown as associated with each of the eight memory controllers 208 for a total of sixteen memory modules forming memory 210 in this illustrative example, the scope of the present invention is not limited to any specific number of memory modules; but rather any number (one or more) of memory modules may be associated with each memory controller for a total of any number (one or more) memory modules that may be implemented in a given co-processor in accordance with embodiments of the present invention. Communication links (or paths) 209 interconnect between the crossbar 207 and memory controllers 208 and between the application engines 202 and the memory controllers 208.

In this example, co-processor 22 also includes a direct input output (I/O) interface 203. Direct I/O interface 203 may be used to allow external I/O to be sent directly into the application engines 22, and then from there, if desired, written into memory system 210. Direct I/O interface 203 of this exemplary embodiment allows a customer to have input or output from co-processor 22 directly to their interface, without going through the host processor's I/O sub-system. In a number of applications, all I/O may be done by the host processor(s) 21, and then potentially written into the co-processor memory 210. An alternative way of bringing input or output from the host system as a whole is through the direct I/O interface 203 of co-processor 22. Direct I/O interface 203 can be much higher bandwidth than the host interface itself. In alternative embodiments, such direct I/O interface 203 may be omitted from co-processor 22.

In operation of the exemplary co-processor 22 of FIG. 2, the application engines 202 are configured to implement the extended instructions for a desired personality. In one embodiment, an image of the extended instructions is loaded into FPGAs of the application engines, thereby configuring the application engines with a corresponding personality. In one embodiment, the personality implements a desired vector processing personality, such as SPV or DPV.

In one embodiment, the host processor(s) 21 executing an application dispatches certain instructions of the application to co-processor 22 for processing. To perform such dispatch, the host processor(s) 21 may issue a write to a memory location being monitored by the host interface 204. In response, the host interface 204 recognizes that the co-processor is to take action for processing the dispatched instruction(s). In one embodiment, host interface 204 reads in a set of cache lines that provide a description of what is suppose to be done by co-processor 22. The host interface 204 gathers the dispatch information, which may identify the specific personality that is desired, the starting address for the routine to be executed, as well as potential input parameters for this particular dispatch routine. Once it has read in the information from the cache, the host interface 204 will initialize the starting parameters in the host interface cache. It will then give the instruction fetch decode unit 205 the starting address of where it is to start executing instructions, and the fetch decode unit 205 starts fetching instructions at that location. If the instructions fetched are canonical instructions (e.g., scalar loads, scalar stores, branch, shift, loop, and/or other types of instructions that are desired to be available in all personalities), the fetch/decode unit 205 sends those instructions to the scalar processor 206 for processing; and if the fetched instructions are instead extended instructions of an application engine's personality, the fetch decode unit 205 sends those instructions to the application engines 202 for processing.

Exemplary techniques that may be employed for dispatching instructions of an executable from a host processor 21 to the co-processor 22 for processing in accordance with certain embodiments are described further in co-pending and commonly-assigned U.S. patent application Ser. No. 11/854,432 (Attorney Docket No. 73225/P002US/10711918) filed Sep. 12, 2007 titled “DISPATCH MECHANISM FOR DISPATCHING INSTRUCTIONS FROM A HOST PROCESSOR TO A CO-PROCESSOR”, the disclosure of which is incorporated herein by reference. As mentioned further herein, in certain embodiments, the executable may specify which of a plurality of different personalities the co-processor is to be configured to possess for processing operations of the executable. Exemplary techniques that may be employed for generating and executing such an executable in accordance with certain embodiments of the present invention are described further in co-pending and commonly-assigned U.S. patent application Ser. No. 11/847,169 (Attorney Docket No. 73225/P003US/10711914) filed Aug. 29, 2007 titled “COMPILER FOR GENERATING AN EXECUTABLE COMPRISING INSTRUCTIONS FOR A PLURALITY OF DIFFERENT INSTRUCTION SETS”, the disclosure of which is incorporated herein by reference. Thus, similar techniques may be employed in accordance with certain embodiments of the present invention for generating an executable that specifies one or more vector processing personalities desired for the co-processor to possess when executing such executable, and for dispatching certain instructions of the executable to the co-processor for processing by its configured vector processing personality.

As the example of FIG. 2 illustrates, certain embodiments of the present invention provide a co-processor that includes one or more application engines having dynamically-reconfigurable personalities (e.g., vector processing personalities), and the co-processor further includes an infrastructure (e.g., infrastructure 211) that is common across all of the personalities. In certain embodiments, the infrastructure 211 comprises an instruction decode infrastructure that is common across all of the personalities, such as is provided by instruction fetch/decode unit 205 of exemplary co-processor 22 of FIG. 2. In certain embodiments, the infrastructure 211 comprises a memory management infrastructure that is common across all of the personalities, such as is provided by memory controllers 208 and memory 210 of exemplary co-processor 22 of FIG. 2. In certain embodiments, the infrastructure 211 comprises a system interface infrastructure that is common across all of the personalities, such as is provided by host interface 204 of exemplary co-processor 22 of FIG. 2. In addition, in certain embodiments, the infrastructure 211 comprises a scalar processing unit having a base set of instructions that are common across all of the personalities, such as is provided by scalar processing unit 206 of exemplary co-processor 22 of FIG. 2. While the exemplary implementation of FIG. 2 shows infrastructure 211 as including an instruction decode infrastructure (e.g., instruction fetch decode unit 205), memory management infrastructure (e.g., memory controllers 208 and memory 210), system interface infrastructure (e.g., host interface 204), and scalar processing unit 206 that are common across all of the personalities, the scope of the present invention is not limited to implementations that have all of these infrastructures common across all of the personalities; but rather any combination (one or more) of such infrastructures may be implemented to be common across all of the personalities in a given co-processor in accordance with embodiments of the present invention.

According to one embodiment of the present invention, the co-processor 22 supports at least two general-purpose vector processing personalities. The first general-purpose vector processing personality is referred to as single-precision vector (SPV), and the second general-purpose vector processing personality is referred to as double-precision vector (DPV). These personalities provide extensions to the canonical ISA that support vector oriented operations. The personalities are appropriate for single and double precision workloads, respectively, with data organized as single or multi-dimensional arrays.

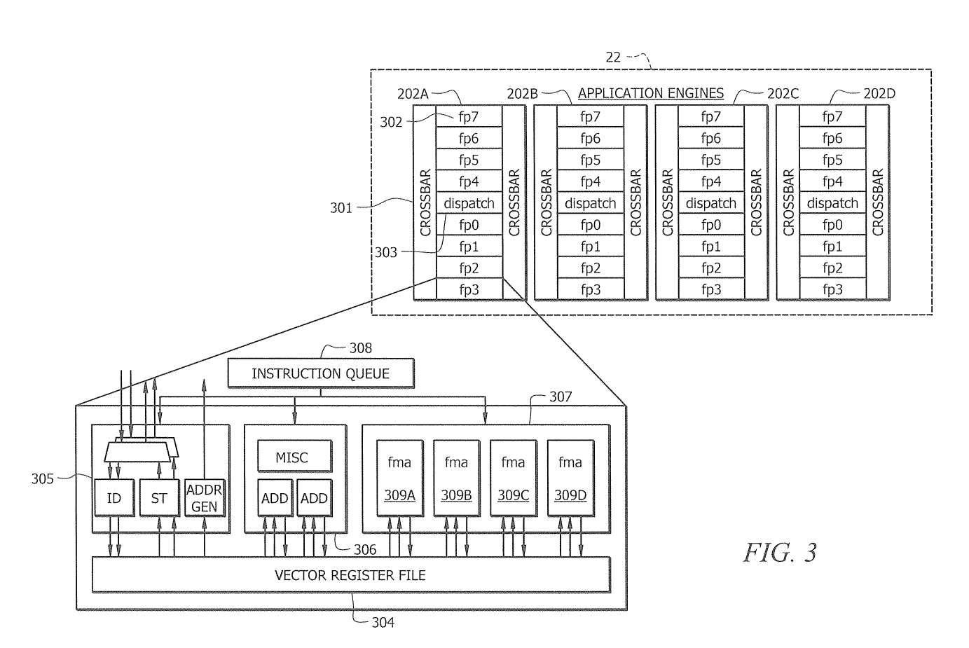

An exemplary implementation of application engines 202A-202D of co-processor 22 of FIG. 2 are shown in FIG. 3. In particular, FIG. 3 shows an example in which the application engines 202 are configured to have a single precision vector (SPV) personality. Thus, the exemplary personality of application engines 202 is optimized for a seismic processing application (e.g., oil and gas application) or other type of application that desires single-precision vector processing. In certain embodiments, the application engines may be dynamically configured to such SPV personality, or in other embodiments, the application engines may be statically configured to such SPV personality. In either case, the vector register partitioning mode employed by the co-processor may be dynamically configured in accordance with certain embodiments of the present invention, as discussed further herein.

In each application engine in the example of FIG. 3, there are function pipes 302. In this example, each application engine has eight function pipes (labeled fp0-fp7). While eight function pipes are shown for each application engine in this illustrative example, the scope of the present invention is not limited to any specific number of function pipes; but rather any number (one or more) of function pipes may be implemented in a given application engine in accordance with embodiments of the present invention. Thus, while thirty-two total function pipes are shown as being implemented across the four application engines in this illustrative example, the scope of the present invention is not limited to any specific number of function pipes; but rather any total number of function pipes may be implemented in a given co-processor in accordance with embodiments of the present invention.

Further, in each application engine, there is crossbar, such as crossbar 301, which is used to communicate or pass memory requests and responses to/from the function pipes 302. Requests from the function pipes 302 go through the crossbar 301 and then to the memory system (e.g., memory controllers 208 of FIG. 2).

The function pipes 302 are where the computation is done within the application engine. Each function pipe receives instructions to be executed from the corresponding application engine's dispatch block 303. For instance, function pipes fp0-fp7 of application engine 202A each receives instructions to be executed from dispatch block 303 of application engine 202A. As discussed further hereafter, each function pipe is configured to include one or more function units for processing instructions. Function pipe fp3 of FIG. 3 is expanded to show more detail of its exemplary configuration in block-diagram form. Other function pipes fp0-fp2 and fp4-fp7 may be similarly configured as discussed below for function pipe fp3.

The instruction queue 308 of function pipe fp3 receives instructions from dispatch block 303. In one embodiment, there is one instruction queue per application engine that resides in the dispatch logic 303 of FIG. 3. The instructions are pulled out of instruction queue 308 one at a time, and executed by the function units within the function pipe fp3. All function units within an application engine perform their functions synchronously. This allows all function units of an application engine to be fed by the application engine's single instruction queue 308. In the example of FIG. 3, there are three function units within the function pipe fp3, labeled 305, 306 and 307. Each function unit in this vector infrastructure performs an operation on one or more vector registers from the vector register file 304, and may then write the result back to the vector register file 304 in yet another vector register. Thus, the function units 305-307 are operable to receive vector registers of vector register file 304 as operands, process those vector registers to produce a result, and store the result into a vector register of a vector register file 304.

In the illustrated example, function unit 305 is a load store function unit, which is operable to perform loading and storing of vector registers to and from memory (e.g., memory 210 of FIG. 2) to the vector register file 304. So, function unit 305 is operable to transfer from the memory 210 (of FIG. 2) to the vector register file 304 or from the vector register file 304 to memory 210. Function unit 306, in this example, provides a miscellaneous function unit that is operable to perform various miscellaneous vector operations, such as shifts, certain logical operations (e.g., XOR), population count, leading zero count, single-precision add, divide, square root operations, etc. In the illustrated example, function unit 307 provides functionality of single-precision vector “floating point multiply and accumulate” (FMA) operations. In this example, four of such FMA operations can be performed simultaneously in the FMA function block 307.

While each function pipe is configured to have one load/store function unit 305, one miscellaneous function unit 306, and one FMA function unit 307 (that includes four FMA blocks), in other embodiments the function pipes may be configured to have other types of function units in addition to or instead of those exemplary function blocks 305-307 shown in FIG. 3. Also, while each function pipe is configured to have three function units 305, 306, and 307 in the example of FIG. 3, in other embodiments the function pipes may be configured to have any number (one or more) of function units.

One example of operation of a function unit configured according to a given personality may be a boolean AND operation in which the function unit may pull out two vector registers from the vector register file 304 to be ANDed together. Each vector register may have multiple data elements. In the exemplary architecture of FIG. 3, there are up to 1024 data elements. Each function pipe has 32 elements per vector register. Since there are 32 function pipes that each have 32 elements per vector register, that provides a total of 1024 elements per vector register across all four application engines 202A-202D. Within an individual function pipe, each vector register has 32 elements in this exemplary architecture, and so when an instruction is executed from the instruction queue 308, those 32 elements, if they are all needed, are pulled out and sent to a function unit (e.g., function unit 305, 306, or 307).

As another exemplary operation, in the illustrated example of FIG. 3, FMA function unit 307 may receive as operands two sets of vector registers from vector register file 304. Function unit 307 would perform the requested operation (as specified by instruction queue 308), e.g., either floating point multiply, floating point add, or a combination of multiply and add; and send the result back to a third vector register in the vector register file 304.

For the exemplary SPV personality shown in FIG. 3, the FMA blocks 309A-309D in function unit 307 all have the same single-precision FMA block in the illustrative example of FIG. 3. So, the FMA blocks 309A-309D are homogeneous in this example. However, it could be that for certain markets or application-types, the customer does not need four FMA blocks (i.e., that may be considered a waste of resources), and so they may choose to implement different operations than four FMAs in the function unit 307. Thus, another vector processing personality may be available for selection for configuring the function units, which would implement those different operations desired. Accordingly, in certain embodiments, the personality of each application engine (or the functionality of each application engine's function units) is dynamically configurable to any of various predefined vector processing personalities that is best suited for whatever the application that is being executed.

While in this illustrative example each vector register of the function pipes includes 32 data elements (e.g., each data element may be 8-bytes in size, allowing two single-precision data values or one double-precision data value), the scope of the present invention is not limited to any specific size of vector registers; but rather any size vector registers (possessing two or more data elements) may be used in a given function unit or application engine in accordance with embodiments of the present invention. Further, each vector register may be a one-dimensional, two-dimensional, three-dimensional, or even other “N”-dimensional array of data in accordance with embodiments of the present invention. In addition, as discussed further herein, dynamically selectable vector register partitioning may be employed.

In the exemplary architecture of FIG. 3, all of the function pipes fp0-fp7 of each application engine are exact replications. Thus, in the illustrated example, there are thirty-two copies of the function pipe (as shown in detail for fp3 of application engine 202A) across the four application engines 202A-202D, and they are all executing the same instructions because this is a SIMD instruction set. So, one instruction goes into the instruction queue of all thirty-two functional pipes, and they all execute that instruction on their respective data.

Thus, the co-processor infrastructure 211 can be leveraged across multiple different vector processing personalities, with the only change being to reconfigure the operations of the function units within the application engines 202 according to the desired personality. In certain implementations, the co-processor infrastructure 211 may remain constant, possibly implemented in silicon where it is not reprogrammable, but the function units are programmable. And, this provides a very efficient way of having a vector personality with reconfigurable function units.

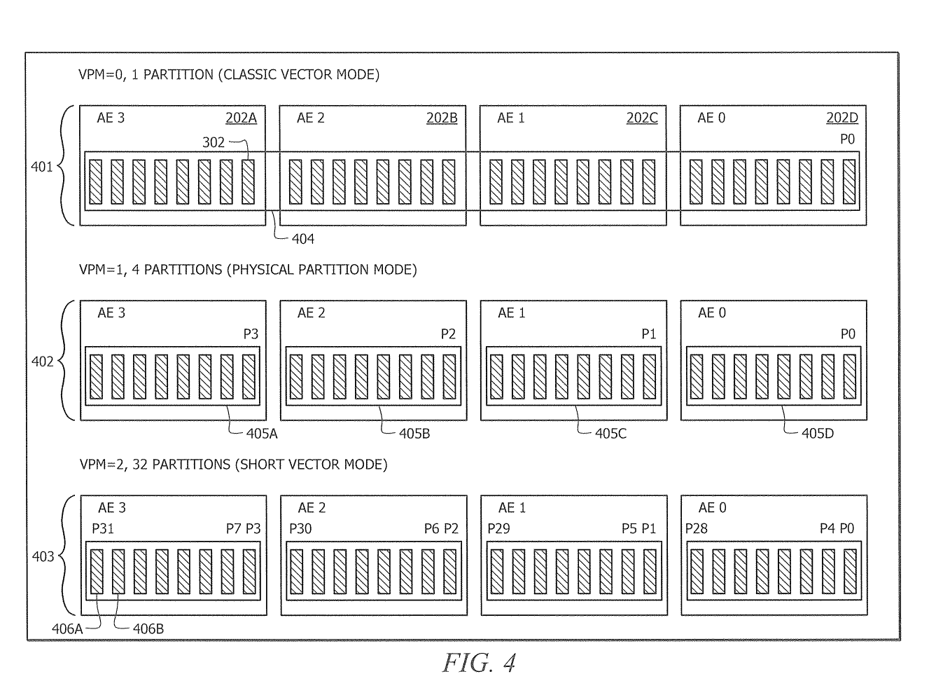

As mentioned above, embodiments of the present invention enable dynamic setting of vector register partitioning to any of a plurality of different vector register partitioning modes. FIG. 4 shows one example of a plurality of different vector register partitioning modes that may be supported within the exemplary co-processor 22 of FIGS. 2-3. While the dynamic setting of vector register partitioning modes is discussed below as applied to the above-described co-processor 22 that has dynamically-reconfigurable personalities, the dynamic setting of vector register partitioning modes is not limited to such co-processor. Rather, the dynamic setting of vector register partitioning modes may likewise be employed within other processors (e.g., host processors, other co-processors, etc.), including other processors that have static personalities.

The exemplary architecture of FIG. 4 supports three vector partitioning modes. Although, in other embodiments, other vector partitioning modes may be defined in addition to or instead of those shown with FIG. 4, and any such other vector partitioning modes are intended to be within the scope of the present invention.

A first vector partitioning mode (“mode 0”) is illustrated in the block 401. Mode 0 is identified in this example by VPM=0. As discussed further herein, there is a field identified by VPM (vector partition mode), and when it is set to 0, then the vector partitioning mode 0 is activated. In this exemplary embodiment, the vector partitioning mode 0 has one partition across all of the vector register elements. That is, one partition is implemented for the four application engines 202A-202D, thereby resulting in each vector register having size 1024 elements in this example. This vector partitioning mode 0 is referred to as classic vector mode.

Within each application engine 202A-202D, there are eight function pipes, shown as function pipes 302 in FIG. 3. The eight function pipes are individually labeled fp0-fp7, as shown in FIG. 3. Thus, in this example, there are a total of 32 function pipes across the four application engines 202A-202D. In the vector partitioning mode 0 (or classic vector mode), those 32 function pipes are arranged into one partition, shown as partition 404.

A second vector partitioning mode (“mode 1”) is illustrated in the block 402. Mode 1 is identified in this example by VPM=1. As discussed further herein, there is a field identified by VPM, and when it is set to 1, then the vector partitioning mode 1 is activated. In this exemplary embodiment, the vector partitioning mode 1, which may be referred to as a physical partition mode, arranges the vector register elements of each application engine 202A-202D into a separate partition. That is, partitions 405A-405D are implemented for the four application engines 202A-202D, respectively, thereby resulting in each vector register having size 256 elements in this example.

A third vector partitioning mode (“mode 2”) is illustrated in the block 403. Mode 2 is identified in this example by VPM=2. As discussed further herein, there is a field identified by VPM, and when it is set to 2, then the vector partitioning mode 2 is activated. In this exemplary embodiment, the vector partitioning mode 2, which may be referred to as a short vector mode, arranges the vector register elements of each function pipe into a separate partition. That is, the vector register of each function pipe within the application engines is arranged into a separate partition, such as partition 506A, 506B, etc., thereby resulting in each vector register having size 32 elements in this example.

In the classic vector mode shown in block 401, all function pipes operate on the data as a single partition 404. Because SIMD is employed in this example, when the function pipes are processing the data (e.g., doing arithmetic operations), the same operation is done on all function units within a vector register partition (e.g., the partition 404 in classic vector mode). It should be noted that in this embodiment, the same operation is performed on all function units independent of the partition mode.

In the physical partition mode shown in block 402, all function pipes of a given application engine operate on the data as a single partition. For instance, the function pipes of application engine 202A operate on the data as a partition 405A, the function pipes of application engine 202B operate on the data as a partition 405B, the function pipes of application engine 202C operate on the data as a partition 405C, and the function pipes of application engine 202D operate on the data as a partition 405D.

In the short vector mode shown in block 403, each individual function pipe operate on the data of its 32 vector register elements as a single partition. Again, under SIMD, the same operation is done on all function units independent of the partition mode.

Typically, when a load/store operation is performed, there is a vector length which specifies how many vector data elements are used, and in this case how many vector data elements are used in each vector partition. In the block labeled 401, for example, there is a single vector register partition 404, and so the vector length specifies how many data elements are used in that single partition 404. The maximum vector length permitted is 1024 elements in this example because there are 32 function pipes with 32 data elements in each function pipe. So, the maximum vector length permitted is 1024 elements in this example, but it may be set to a different size in other embodiments. For instance, in certain embodiments, for a particular segment of an application being executed there may be only 923 data elements, and therefore the maximum vector length may be set to 923 for that particular segment. Then, the other data elements between 923 and 1024 would not participate in those load/store operations. That is how the vector length field may be used in certain embodiments.

Thus, if a shorter length than the maximum permitted vector register length within a given partition is desired, then the vector length may be set to specify the desired shorter length to be used for operations. So, the vector register length may be dynamically set to specify the desired vector register length to be used within a partition.

Vector stride is another defined characteristic in certain embodiments, which may be used for load and store operations. When loading data elements in a vector register partition from memory, if a stride is a stride of 1, then essentially each data element is consecutive in memory (there are not any holes between data elements in memory). So, a vector stride register (referred to herein as “VS”) may be dynamically set to specify whatever the stride size is for the data element. If working with double-precision values, there are eight bytes and so the vector stride may be set to eight. In that case, a load operation would load eight bytes with a stride of eight between them, which is then just consecutively loading the data elements in.

If a larger value is set for the vector stride, then holes that may exist between data elements in memory can be skipped as the data elements are being loaded into the vector register. Say, for example, a vector stride of 16 is set, this would load in 8 bytes into data element 1, skip 8 bytes, load in 8 bytes into data element 2, skip 8 bytes, and so on. So, the vector stride field controls the offset between data elements in a vector register within a partition.

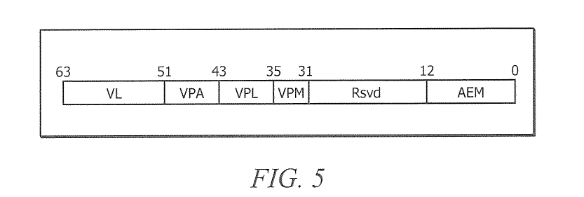

In certain embodiments, an application engine control (AEC) register is provided in the co-processor, which is composed of a number of fields that control various aspects of the application engine. Such an AEC register may be associated with each application engine 202A-202D that is included in the co-processor 22. In other embodiments a single AEC register may be provided, and the value of the AEC register is the same for each application engine. An exemplary AEC register that may be implemented is shown in FIG. 5. In this example, the following fields exist within the AEC register:

AEM (application engine mask): The application engine mask specifies which exceptions are to be masked (i.e., ignored by the co-processor). Exceptions with their mask set to one are ignored.

VPM (vector partition mode): The VPM register is used to set the vector register partition configuration. The vector register partition configuration sets the number of function pipes per partition in this exemplary embodiment, as discussed above with FIG. 4.

VPL (vector partition length field): The VPL field is used to specify the number of vector partitions that are to participate in a vector operation.

VPA (active vector partition field): Instructions that operate on a single partition use the VPA field to determine the active partition for the operation. An example instruction that uses the VPA field is move S-register to a Vector register element. The instruction uses the VPA field to determine which partition the operation is to be applied.

VL (vector length field): The vector length field specifies the number of vector elements in each vector partition.

Accordingly, in certain embodiments, vector register partitioning is used to partition the parallel function units of the application engines 202 to eliminate communication between application engines 202 or provide increased efficiency on short vector lengths. In one embodiment, all partitions participate in each vector operation (vector partitioning is an enhancement that maintains SIMD execution).

An example where eliminating communication between application engines is desired is the FFT algorithm. FFTs require complex data shuffle networks when accessing data elements from the vector register file. With one partition per application engine, i.e. “physical partition mode”, an FFT is performed entirely within a single application engine. Thus, by partitioning the parallel function units into one partition per application engine, communication between application engines is eliminated.

A second exemplary usage of vector register partitioning is for increasing the performance on short vectors. The following code performs addition between two matrices with the result going to a third:
Double A[64][33], B[64][33], C[64][33];
For (int i=0; i<64; i+=1)
   For (int j=0;j<32;j+=1)
      A[i][j]=B[i][j]+C[i][j];
         The declared matrices in the above code are 64 by 33 in size. A compiler's only option is to perform operations one row at a time since the addition is performed on 32 of the 33 elements in each row. In “classic vector mode” (i.e. without vector register partitions), a vector register would use only 32 of a vector register's data elements. With vector register partitioning, a vector register's elements can be partitioned for “short vector operations”. If the vector register has 1024 data elements, then the short vector mode partitioning would result in thirty-two partitions with 32 data elements each. A single vector load operation would load all thirty-two partitions with 32 data elements each. Similarly, a vector add would perform the addition for all thirty-two partitions. Using vector partitions turns a vector operation where 32 data elements are valid within each vector register to an operation with all 1024 data elements being valid. A vector operation with only 32 data elements is likely to run at less than peak performance for the coprocessor, whereas peak performance is likely when using all data elements within a vector register.

Vector register partitioning may be dynamically set to any of a plurality of different vector register partitioning modes. According to one embodiment, each mode ensures that all vector register partitions have the same number of function pipes. The following table shows the allowed modes according to one embodiment:

| | | Vector Register | |
|---|---|---|---|
| Vector Partition | Partition | Data Elements | |
| Mode (VPM) | Count | Per Partition | Mode Description |
| 0 | 1 | VLmax | Classical Vector |
| 1 | 4 | VLmax/4 | Physical Partitioning |
| 2 | 32 | VLmax/32 | Short Vector |

Of course, the present invention is not limited to the exemplary vector register partitioning modes shown in the above table; but rather other vector register partitioning modes may be predefined in addition to or instead of the above-mentioned modes.

131 As one example, such as that discussed above with FIG. 4, assume that the co-processor has 32 function pipes with a vector register having 1024 elements. If the vector partition mode (VPM) register field (in the AEC register of FIG. 5) has the value of 2, then there are 32 register partitions (one for each function pipe) with 32 data elements per partition.

Depending on the vector register partitioning mode activated, any of various different mappings of vector register partitions to function pipes (FPs) may be implemented, such as the exemplary mappings shown in FIG. 4 discussed above.

According to one embodiment, data is mapped to function pipes within a partition based on the following criteria:

Each function pipe has the same number of data elements (±1). The execution time of an operation within a partition is minimized by uniformly spreading the data elements across the function pipes; and

Consecutive vector elements are mapped to the same FP before transitioning to the next function pipe.

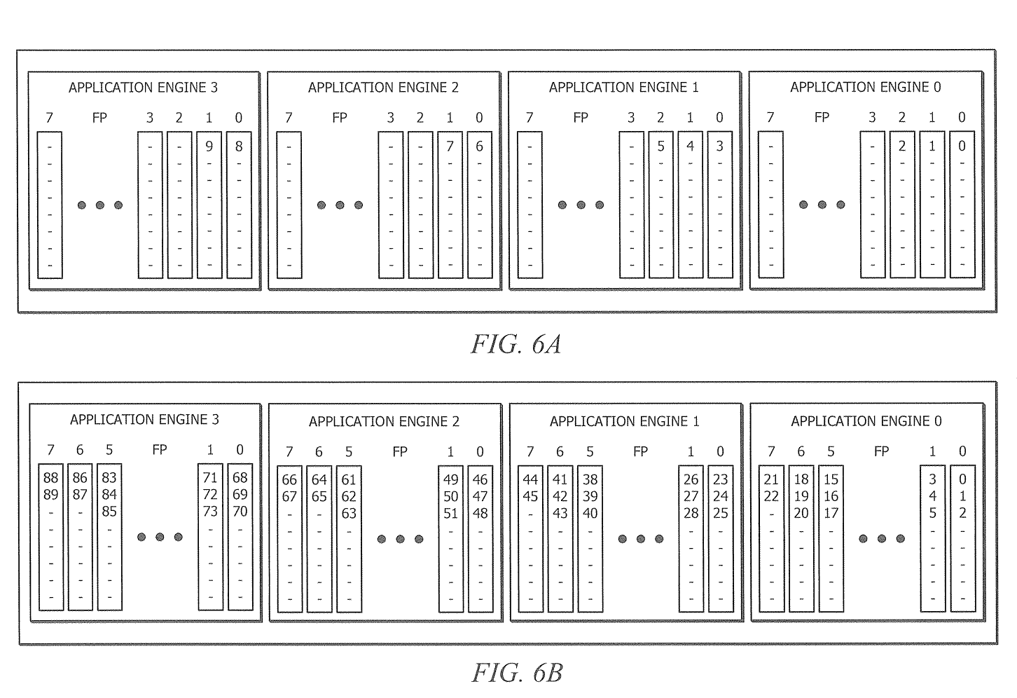

In one embodiment, the mapping of data elements to function pipes in the above-mentioned classic vector partitioning mode (VPM=0) follows the above-mentioned guidelines. The result is that depending on the total number of vector elements (i.e. the value of VL), a specific data element will be mapped to a different application engine/function pipe. FIGS. 6A and 6B show how data elements are mapped in classic vector mode for VL=10 and VL=90, respectively, according to one embodiment. As shown in FIGS. 6A and 6B, the vector register elements are uniformly distributed across the function pipes, and the elements are contiguous within each application engine in this exemplary embodiment.

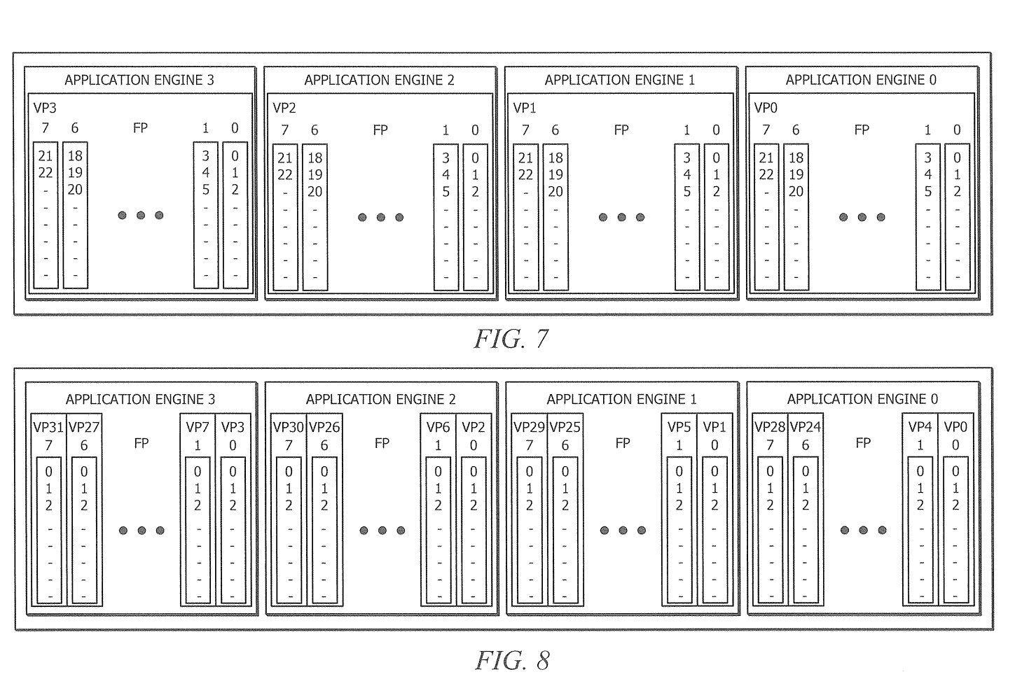

According to one embodiment, in physical partition mode (VPM=1), the elements are mapped to the function pipes within an application engine in a striped manner with all function pipes having the same number of elements (±1). FIG. 7 shows how data elements are mapped in physical partition mode for VL=23, according to one embodiment. The physical partition mode has the same vector length (VL) value per partition in this exemplary embodiment.

According to one embodiment, in short vector mode (VPM=2), the elements are mapped to a single function pipe within each partition. FIG. 8 shows how data elements are mapped in short vector mode for VL=3, according to one embodiment. The short vector mode has a common vector length (VL) value for all partitions in this exemplary embodiment. Note that partitions are interleaved across the application engines to provide balanced processing when not all partitions are being used (i.e. VPL is less than 32), in this embodiment.

While exemplary data mapping for function pipes are described above for the classic, physical partition, and short vector modes, the scope of the present invention is not limited to those exemplary data mapping schemes. Rather, other data mapping schemes may be implemented for one or more of the classic, physical partition, and short vector modes and/or for other vector register partitioning modes that may be defined for dynamic configuration of a processor.

According to one embodiment, three registers exist to control vector partitions. These registers are the Vector Partition Mode (VPM), Vector Partition Length (VPL) and Vector Partition Stride (VPS). In certain embodiments, VPM and VPL are included as fields in the AEC register of FIG. 5 discussed above, while VPS is implemented as a separate 64-bit register.

The Vector Partition Length register indicates the number of vector partitions that are to participate in the vector operation. As an example, if VPM=2 (32 partitions) and VPL=12, then vector partitions 0-11 will participate in vector operations and partitions 12-31 will not participate.

The Vector Partition Stride register (VPS) indicates the stride in bytes between the first data element of consecutive partitions for vector load and store operations.

Note that the Vector Length register indicates the number of data elements that participates in a vector operation within each vector partition. Similarly, the Vector Stride register indicates the stride in bytes between consecutive data elements within a vector partition. The use of these registers (VL and VS) is consistent whether operating in “classic vector mode” with a single partition, or in another vector register mode having multiple partitions.

Various operations may be performed by the co-processor 22 using the dynamically configured vector register partitions. In certain embodiments, vector loads and stores use the VL and VPL registers to determine which data elements within each vector partition are to be loaded or stored to memory. The VL value indicates how many data elements are to be loaded/stored within each partition. The VPL value indicates how many of the vector partitions are to participate in the vector load/store operation.

The VS and VPS registers are used to determine the address for each data element memory access. The pseudo-code below shows an exemplary algorithm that may be used to calculate the address for each data element of a vector load/store.

Instruction:

| | |
|---|---|
| Id.fd V0,offset(A4) | ; floating point double load |
| Pseudo Code: | |
| for (int vp = 0; vp < VPL; vp += 1) | ; vp is the vector partition index |
| for (int ve = 0; ve < VL; ve += 1) | ; ve is the vector register element index |

V0[vp][ ve] = offset + A4 + ve * VS + vp * VPS

Note that setting VS and/or VPS to zero results in the same location of memory being accessed multiple times for a load or store instruction. The following special cases can be created:

| Value of | |
|---|---|
| VPS and | |
| VS | Operation Description |
| VPS == 0, | All partitions receive the same values (i.e. data element zero |
| VS != 0 | of all partitions access the same location in memory, data |
| | element one of all partitions access the next location in |
| | memory). |
| VPS != 0, | Each partition access a different location in memory, but all |
| VS == 0 | data elements within a partition access the same location in |
| | memory. |
| VPS == 0, | All elements in all partitions access the same location in |
| VS == 0 | memory. |

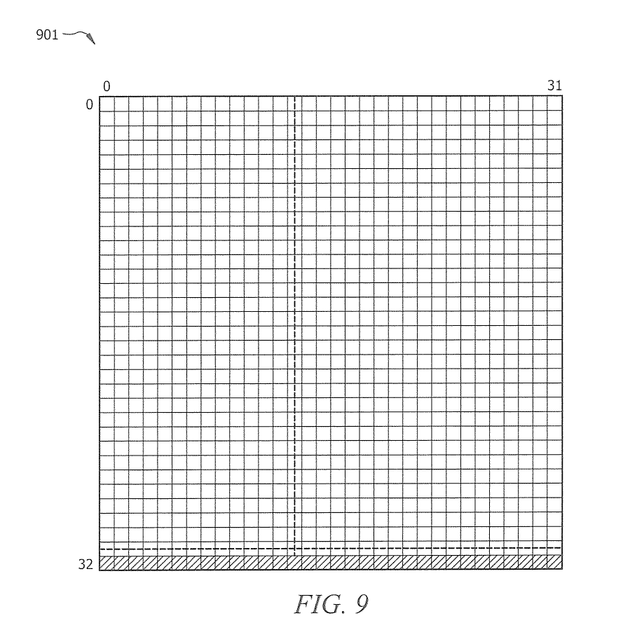

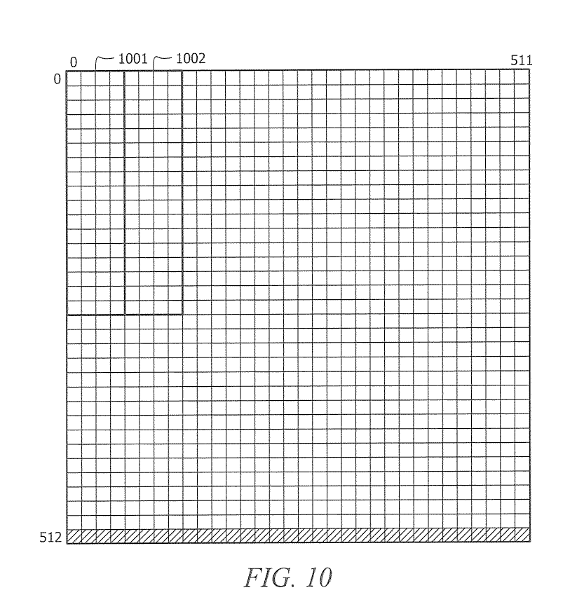

FIG. 9 graphically illustrates one example of using vector register partitioning. In the illustrated example, block 901 indicates a two-dimensional matrix in memory. As shown, it has 32 elements in one dimension, and 33 elements in another dimension. The reason there are 33 elements in one dimension is that the size of the matrix is sometimes increased by a dimension of 1 to have better performance, i.e., by minimizing collisions that occur in memory. While the matrix size has been increased by 1, the interesting data for use in performing operations will reside in this example in a 32 by 32 portion of the matrix. Suppose, that an executable (application) desires to add two of these matrices together, and put the result in a third matrix. The instructions for performing that operation may instruct that for elements 0 to 31 columns, one element at a time in the rows 0 to 31 are to be added for the two sources, and put the result in the destination matrix. Thus, in this example, suppose that there exist two source and one destination arrays that re each 32 by 32 in size, but due to memory bank contention has been declared as 32 by 33 in this example.

According to embodiments of the present invention, the vector register partitioning mode may be dynamically selected to perform the above-mentioned operation efficiently. For instance, the add between the two source arrays with the result being placed in the destination array can be performed with the following settings:
VPM=2 (short vector mode)
VL (vector length)=32
VS (element size)=8 (assuming the operation is double-precision, and thus 8 bytes per)
VPL (vector partition length)=32
VPS=8*33 (column size)

With the above settings, an add between the source arrays may be performed by:
LD.QW 0(A1),V1; A1 has source_1 base address
LD.QW 0(A2),V2; A2 has source_2 base address
ADD.QW V1,V2,V3
ST.QW V3, 0(A3); A3 has destination base address

So, by doing one load instruction with the above-set parameters of the short vector mode, all 1024 of the elements are loaded into the vector registers. So, the two load instructions are executed above to load the two source matrices, and one add operation is performed, which adds the two vector registers together, using the function pipe. So, in one register in a vector register file, there is an entire source array, and in a second register there is a second source array. The addition operation sends those elements, one at a time, through the function pipe to do the add, and it writes it back to a third vector register which is the destination vector register. And then a store operation is performed, which takes the elements out of the vector register, uses all the set parameters (the strides and the lengths), to store the result back to memory in the third destination matrix. And so, the vector register partitioning may be very useful when you have a short vector length, but you have a second dimension with many elements.

Suppose that instead of setting the vector register partition mode to the short vector mode it is set to the classic vector mode (VPM=0) for the above-described add operation. In that case, the vector length is still 32 because the operation can only deal with 32 in a column which cannot be changed through programming language semantics. The vector stride is still 8, so everything within a partition is still the same, but by definition there is only one partition. So, the vector partition length is 1, and the vector partition stride does not matter. The result of this is that only 32 elements are loaded in, and so the processor has to loop 32 times to all of the stores.

FIG. 10 graphically illustrates another example of using vector register partitioning. In the illustrated example of FIG. 10, a two-dimensional matrix in memory is shown having 512 elements in one dimension and 513 elements in another dimension. Again suppose that an addition operation is desired as discussed above with FIG. 9. In the example of FIG. 10, the vector register partitioning mode may be dynamically set to the physical vector mode in which case there are four partitions, and each partition is 256 elements in size. And so, the following settings may be established:
VPM=1 (physical partition mode)
VL (vector length)=256
VS (element size)=8 (assuming the operation is double-precision, and thus 8 bytes per)
VPL (vector partition length)=4
VPS=8*513 (column size)

With the above settings, an add between the source arrays may again be performed by:
LD.QW 0(A1),V1; A1 has source_1 base address
LD.QW 0(A2),V2; A2 has source_2 base address
ADD.QW V1,V2,V3
ST.QW V3, 0(A3); A3 has destination base address

So, with this configuration the co-processor is actually processing a small piece of the actual total array in each execution of the loop of load, load, add, store. So, it is processing a section that is 4 columns wide by 256 rows tall. In each of the physical partitions, there are 8 function pipes with 32 elements each, which is 256 element. Thus, when a load is performed, one physical partition would load the elements of one column, all 256 (32 for each of the 8 function pipes). This would be performed for all four of the partitions, resulting in loading 4 columns by 256 elements in each column. Once the load, load, add, and store operation completes, the base address A1, A2 and A3 is then moved to point to the next four over (based on the defined VPL parameter), and then the same load, load, add, store would be performed for that operation. So, a first portion of the array, shown as portion 1001 in FIG. 10, is first completed, and then the next portion, shown as portion 1002 in FIG. 2, is next completed.

In the example of FIG. 10, the physical partitioning mode is chosen for use. However, the short vector mode could instead be used, just as in the example of FIG. 9, in which case the processor would actually be working on a 32×32 matrix within the larger matrix of FIG. 10. In some other cases, the 32×32 matrix (of the short vector mode) may not be a good alternative. Suppose, for instance, if the operand matrix has 16 columns, and thus 32 is too big; so, a vector register partitioning that provides 4 columns would fit better.

Likewise, instead of the physical partitioning mode, the classic vector mode may have been used in the example of FIG. 10, in which case the co-processor would operate only on a single column at a time. In doing that, the co-processor would only be using half the elements in each function pipe because in classic mode, there are a total of 1024 elements, but the exemplary matrix of FIG. 10 has only 512 in a column. So, the efficiency would not be quite as high because the co-processor would have to dispatch more instructions (it would be doing half as much work per instruction).

Scalar/Vector operations are operations where a scalar value is applied to all elements of a vector. When considering vector register partitions, vector/scalar operations take on two forms. The first form is when all elements of all partitions use the same scalar value. Operations of this form are performed using the defined scalar/vector instructions. An example instruction would be:
ADD.FD V1,S3,V2
   The addition operation adds S3 plus elements of V1 and puts the result in V2. The values of VPM, VPL and VL determine which elements of the vector operation are to participate in the addition. The key in this example is that all elements that participate in the operation use the same scalar value.

The second scalar/vector form is when all elements of a partition use the same scalar value, but different partitions use different scalar values. In this cases there is a vector of scalar values, one value for each partition. This form is handled as a vector operation. The multiple scalars (one per partition) are loaded into a vector register using a vector load instruction with VS equal zero, and VPS non-zero. Setting VS equal to zero has the effect of loading the same scalar value to all elements of a partition. Setting VPS to a non-zero value results in a different value being loaded into each partition.

The following example shows how vector partitioning can be used to efficiently perform the following sample code.
Double A[16][32], B[16][32], C[16];
For (int i=0; i<16; i+=1)
   For (int j=0; j<32; j+=1)
      A[i][j]=B[i][j]+[i];

### Coprocessor Instructions:

| | | |
|---|---|---|
| MOV | 4, VPM | ; 16 partitions |
| MOV | 32, VL | ; 32 elements per partition |
| MOV | 16, VPL | ; all 16 partitions participate |
| MOV | 0, VS | ; stride of zero within partition |
| MOV | 1, VPS | ; stride of one between partitions |
| LD.FD | addr_C, VO | ; replicate C values for all |
| | | elements of a partition |
| MOV | 1, VS | ; stride of one within partition |
| MOV | 32, VPS | ; stride of 32 between partitions |
| LD.FD | addr_B, V1 | |
| ADD.FD | V0, V1, V2 | |
| ST.FD | V2, addr_A | |

The above sequence of code illustrates exemplary techniques that could be used on the inner loop of a matrix multiple routine.

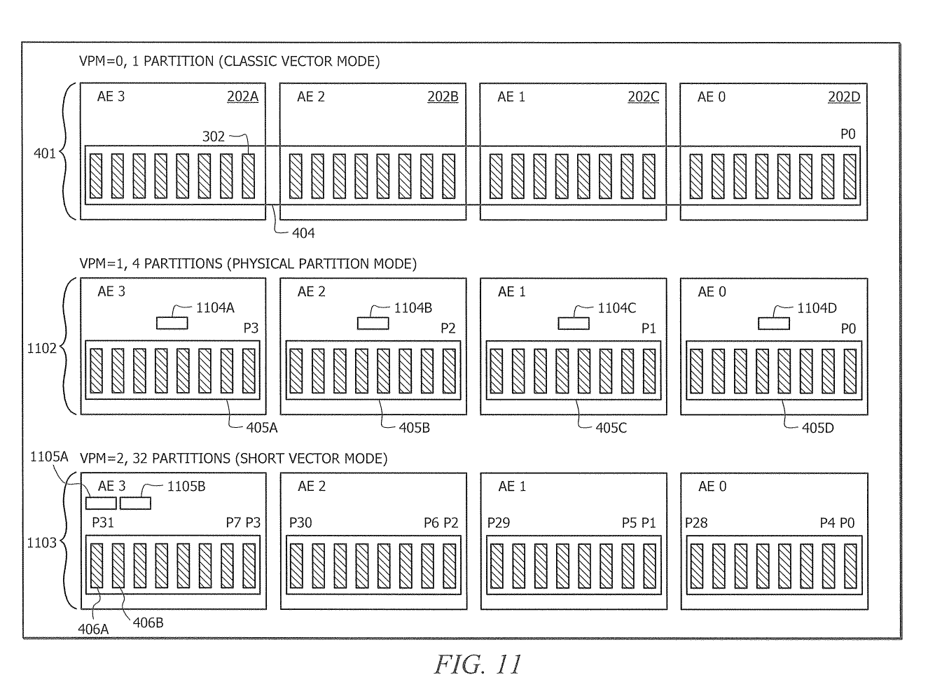

Turning to FIG. 11, an example of employing vector partition scalars according to one embodiment of the present invention is shown. As mentioned above, a scalar value when applied to a vector operation would mean that the same value is being used for every element of that operation, for example. Say, for instance, that the co-processor is configured into the classic vector mode (VPM=0), where the vector register contains up to 1024 elements, and suppose an operation desires to add the value 1 to every one of those single elements. In other words, the operation desires to add the scalar value 1 to every element in the vector register. In tradition vector processing, the scalar registers that are defined in scalar processor 206 (FIG. 2), as they are needed, would be sent over to the application engines 202 to be used to do the scalar operations on the vector elements.

However, in certain vector register partitioning modes, there may be times when it is desired to add a scalar value to the elements of a vector, but use a different scalar value for each partition. So, in the classic vector mode (illustrated in block 401 of FIG. 11), there exists one partition, and so the traditional use of the scalar register of scalar processor 206 can be used in that instance. However, in the exemplary embodiment of FIG. 11, the physical partition mode 1102 and the short vector mode 1103 are implemented to allow different scalar values to be specified for each of the various different vector register partition that are defined in those respective modes. For instance, in the physical partition mode 1102, there are scalar blocks 1104A, 1104B, 1104C and 1104D implemented in the partitions 405A-405D, respectively. This shows one scalar per partition for the physical partition mode. Similarly, in the short vector mode 1103, where there are 32 partitions, there may likewise be one scalar block implemented for each partition, such as the scalar blocks 1105A-1105B that are expressly illustrated in the FIGURE for partitions 406A-406B, respectively (while not shown for ease of illustration, the remaining partitions would likewise have respective scalar blocks. Different scalar values may be defined for each of the different partitions in this way. This would allow the co-processor to execute a particular add operation referring to a scalar partition, wherein the co-processor may choose the scalar partition registers within the application engines to be used to add each element, say, of that function.

While vector partitioning scalars are shown as implemented for physical partition mode and short vector partition mode in FIG. 11, it should be understood that such vector partitioning scalars may likewise be employed for other vector register partitioning modes that may be defined in accordance with embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for processing data comprising:
analyzing structure of data to be processed; and
selecting one of a plurality of vector register partitioning modes based on said analyzing, wherein said vector register partitioning modes define how vector register elements are to be partitioned for processing said data.

2. The method of claim 1 further comprising:
dynamically setting a processor to use the selected one of the plurality of vector register partitioning modes for partitioning vector register elements of the processor.

3. The method of claim 2 wherein the processor comprises a co-processor in a multi-processor system.

4. The method of claim 2 wherein the selecting comprises:
selecting said one of the plurality of vector register partitioning modes to partition said vector register elements of the processor to optimize performance of vector processing operations by the processor.

5. The method of claim 2 wherein the processor comprises a plurality of application engines; each of the plurality of application engines comprises a plurality of function pipes; and each of the plurality of function pipes comprises a set of vector registers that each contain vector register elements.

6. The method of claim 5 wherein the plurality of vector register partitioning modes comprise at least:
a classic vector mode in which all vector register elements of the processor form a single partition;
a physical partition mode in which vector register elements of each of said application engines form a separate partition; and
a short vector mode in which the vector register elements of each of said function pipes form a separate partition.

7. The method of claim 1 further comprising:
dynamically setting, for a selected vector register partitioning mode, a vector stride and a vector partition stride for controlling memory access pattern when performing a vector register memory load or store.

8. A co-processor in a multi-processor system, the co-processor comprising:
at least one application engine having vector registers containing vector register elements for storing data for vector oriented operations by the at least one application engine; and
said at least one application engine being dynamically settable to any of a plurality of different vector register partitioning modes, wherein said vector register elements are partitioned according to the vector register partitioning mode to which the at least one application engine is dynamically set.

9. The co-processor of claim 8 further comprising:
a control register comprising dynamically settable information for setting a vector stride and a vector partition stride for controlling memory access pattern when performing a vector register memory load or store.

10. The co-processor of claim 8 further comprising:
said at least one application engine further comprising at least one configurable function unit that is configurable to any of a plurality of different vector processing personalities.

11. The co-processor of claim 10 further comprising:
a co-processor infrastructure common to all the plurality of different vector processing personalities.

12. The co-processor of claim 11 wherein the co-processor infrastructure comprises:
a memory management infrastructure, a system interface infrastructure for interfacing with a host processor, and an instruction decode infrastructure that are common to all the plurality of different vector processing personalities.

13. The co-processor of claim 12 wherein the co-processor infrastructure further comprises:
a scalar processing unit that comprises a fixed set of instructions, where said scalar processing unit is common to all the plurality of different vector processing personalities.

14. The co-processor of claim 11 wherein said plurality of different vector processing personalities comprise: a single-precision vector processing personality and a double-precision vector processing personality.

15. The co-processor of claim 8 comprising:
a plurality of said application engines;
each of the plurality of application engines comprising a plurality of function pipes; and
each of the plurality of function pipes comprising a set of vector registers containing vector register elements.

16. The co-processor of claim 15 wherein the plurality of vector register partitioning modes comprise:
a classic vector mode in which all vector register elements of the function pipes form a single partition;
a physical partition mode in which vector register elements of each of said application engines form a separate partition; and
a short vector mode in which the vector register elements of each of said function pipes form a separate partition.

17. A system for processing data comprising:
at least one application engine having at least one configurable function unit that is configurable to any of a plurality of different vector processing personalities;
an infrastructure common to all the plurality of different vector processing personalities;
vector registers containing vector register elements for storing data for vector oriented operations by the at least one application engine; and
wherein said at least one application engine is dynamically settable to any of a plurality of different vector register partitioning modes, said vector register partitioning mode to which the at least one application engine is dynamically set defining how said vector register elements are partitioned.

18. The system of claim 17 wherein said infrastructure comprises virtual memory and instruction decode infrastructure.

19. The system of claim 17 wherein the infrastructure comprises:
a memory management infrastructure, a system interface infrastructure for interfacing with a host processor, and an instruction decode infrastructure that are common to all the plurality of different vector processing personalities.

20. The system of claim 17 wherein the infrastructure further comprises:
a scalar processing unit that comprises a fixed set of instructions, where said scalar processing unit is common to all the plurality of different vector processing personalities.

21. The system of claim 17 wherein said plurality of different vector processing personalities comprise: a single-precision vector processing personality and a double-precision vector processing personality.

22. The system of claim 17 comprising:
a plurality of said application engines;
each of the plurality of application engines comprising a plurality of function pipes; and
each of the plurality of function pipes comprising a set of vector registers containing vector register elements.

23. The system of claim 22 wherein the plurality of vector register partitioning modes comprise:
a classic vector mode in which all vector register elements of the function pipes form a single partition;
a physical partition mode in which vector register elements of each of said application engines form a separate partition; and
a short vector mode in which the vector register elements of each of said function pipes form a separate partition.

24. A multi-processor system comprising:
a host processor; and
a co-processor, said co-processor including vector registers containing vector register elements for storing data for vector oriented operations by the co-processor;
a control register comprising dynamically settable information for dynamically setting said co-processor to any of a plurality of different vector register partitioning modes, wherein said vector register elements are partitioned according to the vector register partitioning mode to which the co-processor is dynamically set; and
said control register comprising dynamically settable information for setting at least one of a vector stride and a vector partition stride for controlling memory access pattern when said co-processor is performing a vector register memory load or store.

25. The multi-processor system of claim 24 wherein said control register comprises dynamically settable information for setting both said vector stride and vector partition stride.

26. The multi-processor system of claim 24 wherein said co-processor further comprises:
at least one configurable function unit that is configurable to any of a plurality of different vector processing personalities.

27. The multi-processor system of claim 26 where said co-processor further comprises:
a virtual memory and instruction decode infrastructure that is common to all the plurality of different vector processing personalities.

28. The multi-processor system of claim 24 wherein said co-processor comprises:
a plurality of application engines;
each of the plurality of application engines comprising a plurality of function pipes; and
each of the plurality of function pipes comprising a vector register containing vector register elements.

29. The multi-processor system of claim 28 wherein the plurality of vector register partitioning modes comprise:
a classic vector mode in which all vector register elements of the function pipes form a single partition;
a physical partition mode in which vector register elements of each of said application engines form a separate partition; and
a short vector mode in which the vector register elements of each of said function pipes form a separate partition.

30. A method comprising:
initiating an executable file for processing instructions of the executable file by a multi-processor system, wherein the multi-processor system comprises a host processor and a co-processor;
setting said co-processor to a selected one of a plurality of different vector register partitioning modes, said selected vector register partitioning mode defining how vector register elements of the co-processor are partitioned for use in performing vector oriented operations for processing a portion of the instructions of the executable file;
processing, by the multi-processor system, the instructions of the executable file, wherein a portion of the instructions are processed by the host processor and a portion of the instructions are processed by the co-processor.

31. The method of claim 30 wherein said co-processor comprises:
a plurality of application engines;
each of the plurality of application engines comprising a plurality of function pipes; and
each of the plurality of function pipes comprising a vector register containing a plurality of vector register elements; and wherein the plurality of vector register partitioning modes comprise:
a classic vector mode in which all vector register elements of the function pipes form a single partition;
a physical partition mode in which vector register elements of each of said application engines form a separate partition; and
a short vector mode in which the vector register elements of each of said function pipes form a separate partition.

32. A method comprising:
initiating an executable file for processing instructions of the executable file by a multi-processor system, wherein the multi-processor system comprises a host processor and a co-processor;
determining one of a plurality of different vector register partitioning modes desired for the co-processor, said desired vector register partitioning mode defining how vector register elements of the co-processor are partitioned for use in performing vector oriented operations for processing a portion of the instructions of the executable file;
when determined that the co-processor is set to the desired vector register partitioning mode, dynamically setting the co-processor to the desired vector register partitioning mode; and
processing, by the multi-processor system, the instructions of the executable file, wherein a portion of the instructions are processed by the host processor and a portion of the instructions are processed by the co-processor.

33. The method of claim 32 wherein said co-processor comprises:
a plurality of application engines;
each of the plurality of application engines comprising a plurality of function pipes; and
each of the plurality of function pipes comprising a vector register containing vector register elements; and wherein the plurality of vector register partitioning modes comprise:
a classic vector mode in which all vector register elements of the function pipes form a single partition;
a physical partition mode in which vector register elements of each of said application engines form a separate partition; and
a short vector mode in which the vector register elements of each of said function pipes form a separate partition.
